(19) United States
(12) Patent Application Publication
(10) Pub. No.: US 2025/0335482 A1
(43) Pub. Date: Oct. 30, 2025

(54) RESPONSE ENHANCED SEMI-SUPERVISED DIALOGUE QUERY GENERATION

(71) Applicant: Tencent America LLC, Palo Alto, CA (US)

(72) Inventor: Linfeng SONG, Bellevue, WA (US)

(73) Assignee: Tencent America LLC, Palo Alto, CA (US)

(21) Appl. No.: 18/650,567

(22) Filed: Apr. 30, 2024

(51) Int. Cl. G06F 16/33; G06F 40/35; G06F 40/40

(52) U.S. Cl. CPC G06F 16/3344; G06F 40/35; G06F 40/40

(57) ABSTRACT

This disclosure relates to methods, apparatus, and storage medium for improving a query producer. The method includes constructing training samples comprising a first dialogue corpus and corresponding queries by, for each dialogue in a second dialogue corpus: predicting a plurality of first queries with a query producer based on a dialogue history of the dialogue, and predicting a query with a response-augmented query producer based on the dialogue history and a dialogue response, quantifying a maximum similarity score between the predicted query and each query of the first queries, determining whether the maximum similarity score is larger than or equal to a pre-defined threshold, and in response to determining that the maximum similarity score is larger, constructing the training samples by including the dialogue history of the dialogue into the first dialogue corpus; and training the query producer with the dialogue history of the first dialogue corpus and the corresponding queries.

### FIELD OF THE TECHNOLOGY

The present disclosure relates to machine learning framework for natural language processing, and in particular, to an improvement of dialogue query generation with response enhanced semi-supervised dialogue query producer.

### BACKGROUND OF THE DISCLOSURE

Recent years have witnessed the burgeoning of pre-trained language models (PLMs) and large language models (LLMs), which may effectively improve the performance of various downstream tasks and pave the way for artificial general intelligence. In some implementations, despite variation in size, these models may fail to generate factual content, which is known as hallucination.

In some implementations, to tackle this issue, external knowledge from search engines may be explored. Typically, to bridge a model with a search engine, a query producer is used to generate search queries for retrieving relevant websites. There are various issues/problems associated with this approach. For example, merely taking user questions or keywords as search queries may be ineffective when handling distinct domains or complex dialogue contexts. Another problem may include data scarcity and/or domain adaptation, e.g., a sufficiently large amount of training data may be needed to improve some models, while properly labeling a dialogue for training purpose and/or collecting query annotations is costly.

The present disclosure describes various embodiments for constructing a query producer for generating search queries from dialogue histories, addressing at least one of the issues/problems discussed above. The present disclosure improves the technical field of artificial intelligence (AI) and machine learning, particularly in the field of natural language processing, and improves the effectiveness of the query producer, particularly in cross-domain situations and/or low-resource scenarios.

### SUMMARY

The present disclosure describes various embodiments of methods, apparatus, and computer-readable storage medium for improving a query producer.

According to one aspect, an embodiment of the present disclosure provides a method for improving a query producer. The method is performed by a device including one or more memories and one or more processors in communication with the one or more memories. The method includes constructing a set of training samples comprising a first dialogue corpus and corresponding queries by, for each dialogue in a second dialogue corpus: predicting a plurality of first queries with a query producer based on a dialogue history of the dialogue, and predicting a query with a response-augmented query producer based on the dialogue history and a dialogue response of the dialogue, quantifying a maximum similarity score between the predicted query and each query of the first queries, determining whether the maximum similarity score is larger than or equal to a pre-defined threshold, and in response to determining that the maximum similarity score is larger than or equal to the pre-defined threshold, constructing the training samples by including the dialogue history of the dialogue into the first dialogue corpus and including the predicted query as the dialogue's corresponding query; and training the query producer with the dialogue history of the first dialogue corpus and the corresponding queries to improve the query producer. Each of the query producer and the response-augmented query producer comprises a text-to-text transformer.

According to another aspect, an embodiment of the present disclosure provides an apparatus for improving a query producer. The apparatus includes a memory storing instructions; and a processor in communication with the memory. When the processor executes the instructions, the processor is configured to cause the apparatus to perform, constructing a set of training samples comprising a first dialogue corpus and corresponding queries by, for each dialogue in a second dialogue corpus: predicting a plurality of first queries with a query producer based on a dialogue history of the dialogue, and predicting a query with a response-augmented query producer based on the dialogue history and a dialogue response of the dialogue, quantifying a maximum similarity score between the predicted query and each query of the first queries, determining whether the maximum similarity score is larger than or equal to a pre-defined threshold, and in response to determining that the maximum similarity score is larger than or equal to the pre-defined threshold, constructing the training samples by including the dialogue history of the dialogue into the first dialogue corpus and including the predicted query as the dialogue's corresponding query; and training the query producer with the dialogue history of the first dialogue corpus and the corresponding queries to improve the query producer, wherein each of the query producer and the response-augmented query producer comprises a text-to-text transformer.

In another aspect, an embodiment of the present disclosure provides a non-transitory computer readable storage medium storing instructions. When the instructions are executed by a processor, the instructions cause the processor to perform, constructing a set of training samples comprising a first dialogue corpus and corresponding queries by, for each dialogue in a second dialogue corpus: predicting a plurality of first queries with a query producer based on a dialogue history of the dialogue, and predicting a query with a response-augmented query producer based on the dialogue history and a dialogue response of the dialogue, quantifying a maximum similarity score between the predicted query and each query of the first queries, determining whether the maximum similarity score is larger than or equal to a pre-defined threshold, and in response to determining that the maximum similarity score is larger than or equal to the pre-defined threshold, constructing the training samples by including the dialogue history of the dialogue into the first dialogue corpus and including the predicted query as the dialogue's corresponding query; and training the query producer with the dialogue history of the first dialogue corpus and the corresponding queries to improve the query producer, wherein each of the query producer and the response-augmented query producer comprises a text-to-text transformer.

The above and other aspects and their implementations are described in greater detail in the drawings, the descriptions, and the claims.

### BRIEF DESCRIPTION OF THE DRAWINGS

The system, device, product, and/or method described in the present disclosure may be better understood with reference to the following drawings and description of non-limiting and non-exhaustive embodiments. The components in the drawings are not necessarily to scale. Emphasis instead is placed upon illustrating the principles of the present disclosure.

FIG. 1A shows a schematic diagram of one exemplary embodiment in the present disclosure.

FIG. 1B shows a schematic diagram of a portion of the exemplary embodiment shown in FIG. 1A.

FIG. 1C shows a schematic diagram of a portion of the exemplary embodiment shown in FIG. 1A.

FIG. 1D shows a schematic diagram of a portion of the exemplary embodiment shown in FIG. 1A.

FIG. 2 is a schematic diagram of an electronic device disclosed in the present disclosure.

FIG. 3 is a flow diagram of an embodiment disclosed in the present disclosure.

FIG. 4 shows two examples with corresponding dialogue responses, gold queries, and model predictions.

FIG. 5A shows a schematic diagram of an embodiment in the present disclosure.

FIG. 5B shows a schematic diagram of another embodiment in the present disclosure.

FIG. 6 shows some experimental result of various embodiments in the present disclosure.

FIG. 7 shows some experimental result of various embodiments in the present disclosure.

FIG. 8 shows some experimental result of various embodiments in the present disclosure.

FIG. 9 shows some experimental result of various embodiments in the present disclosure.

FIG. 10 shows some experimental result of various embodiments in the present disclosure.

FIG. 11 shows some experimental result of various embodiments in the present disclosure.

FIG. 12 shows some experimental result of various embodiments in the present disclosure.

FIG. 13 shows some experimental result of various embodiments in the present disclosure.

### DETAILED DESCRIPTION OF THE DISCLOSURE

The invention will now be described in detail hereinafter with reference to the accompanied drawings, which form a part of the present invention, and which show, by way of illustration, specific examples of embodiments. Please note that the invention may, however, be embodied in a variety of different forms and, therefore, the covered or claimed subject matter is intended to be construed as not being limited to any of the embodiments to be set forth below. Please also note that the invention may be embodied as methods, devices, components, or systems. Accordingly, embodiments of the invention may, for example, take the form of hardware, software, firmware or any combination thereof.

Throughout the specification and claims, terms may have nuanced meanings suggested or implied in context beyond an explicitly stated meaning. The phrase “in one embodiment” or “in some embodiments” as used herein does not necessarily refer to the same embodiment and the phrase “in another embodiment” or “in other embodiments” as used herein does not necessarily refer to a different embodiment. Likewise, the phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments/implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes various embodiments for constructing a query producer for generating search queries from dialogue histories, addressing at least one of issues/problems existing in the field of natural language processing, improving the effectiveness of the query producer, particularly in cross-domain situations and/or low-resource scenarios.

Recent years have witnessed the burgeoning of pre-trained language models (PLMs) and large language models (LLMs), which effectively improve the performance of various downstream tasks and pave the way for artificial general intelligence. Despite the variation in size, these models may still fail to generate factual content, which is known as hallucination, and incorporating external knowledge from search engines may be explored to tackle this issue. Typically, to bridge a model with a search engine, a query producer is used to generate search queries for retrieving relevant websites. The present disclosure describes dialogue query generation, which is more challenging as it has to mine user intents from complex dialogue contexts.

In some implementations, using a search engine to exploit knowledge from the Internet is gaining popularity for benefiting various knowledge-intensive tasks, such as open domain questions and answers (QA), and dialogue response. Early attempts simply take user questions or keywords as search queries but have been proven to be ineffective when handling distinct domains or complex dialogue contexts. In some implementations, a query producer may be trained to extract or generate search queries, with query generation more popular due to the limitation of extraction. With the release of various query generation datasets, some query producers may be trained in supervised learning manners.

In some implementations, as query annotations are costly to collect, additional supervision signals may be introduced to train query producers. For example, some large language model (LLM) products may use prompting techniques to generate search queries instead of adopting an independent query producer. However, prompting techniques heavily rely on the ability of LLMs to understand the prompt, which may not be desirable in some implementations, for example, some experimental results show that even ChatGPT has inferior performance than a smaller task-specific model.

In some implementations, supervised learning method may be used to train a query producer, wherein conversations with annotated search queries are used to fine-tune a pre-trained model. However, it is costly to construct a dataset with enough human annotations, and the trained model may still have a disappointing performance in out-of-domain conversations. In some implementations, semi-supervised learning may be used to tackle the above issue/problem: it suits the dialogue query generation task well because abundant conversations without annotated queries are easy to obtain. As implemented in self-training, the model may generate pseudo queries for unlabeled conversations. While in practice, some pseudo queries are often unsatisfying, which may lead to error accumulation and model performance degradation. The challenge of effectively collecting high-quality pseudo queries to construct pseudo instances may be a hurdle, which is addressed by various embodiments in the present disclosure.

Leveraging vast and continually updated knowledge from the Internet has been considered an important ability for a dialogue system. In some implementations, efforts were devoted to collecting conversations with annotated queries and training a query producer (QP) via standard supervised learning. However, some implementations may still face the challenges of data scarcity and domain adaptation. To address these issues, various embodiments in the present disclosure include a semi-supervised learning framework—SemiDQG, to improve model performance with unlabeled conversations.

The present disclosure describes embodiments of dialogue query generation with a query producer (QP) for generating search queries from dialogue histories, submitting the generated search queries to a search engine for retrieving relevant websites on the internet, and/or constructing a response to the dialogue histories based on content in the retrieved websites. Based on the observation that the search query is typically related to the topic of dialogue response, a response-augmented query producer (RA) is trained to provide rich and effective training signals for QP. In some implementations, a similarity-based query selection strategy may be applied to select high-quality RA-generated pseudo queries, which are used to construct pseudo instances for training QP and RA. REINFORCE algorithm may be adopted to further enhance QP, with RA-provided rewards as fine-grained training signals. Some experimental results and in-depth analysis of three benchmarks show the effectiveness of various embodiments in the present disclosure in cross-domain and low-resource scenarios.

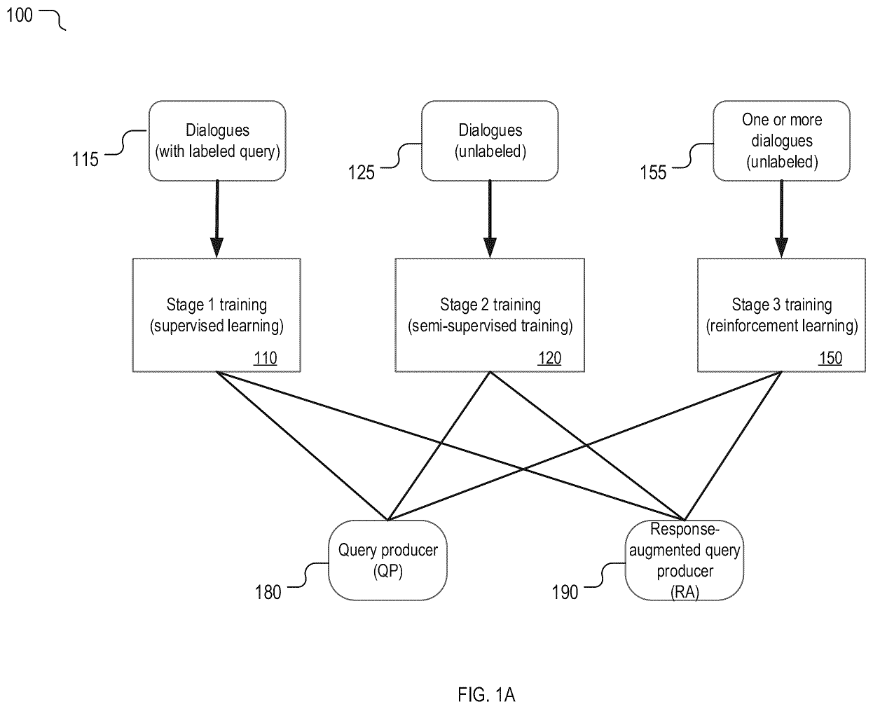

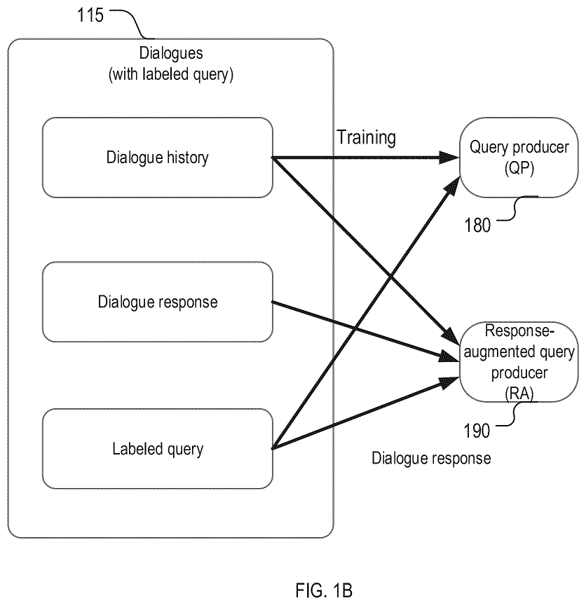

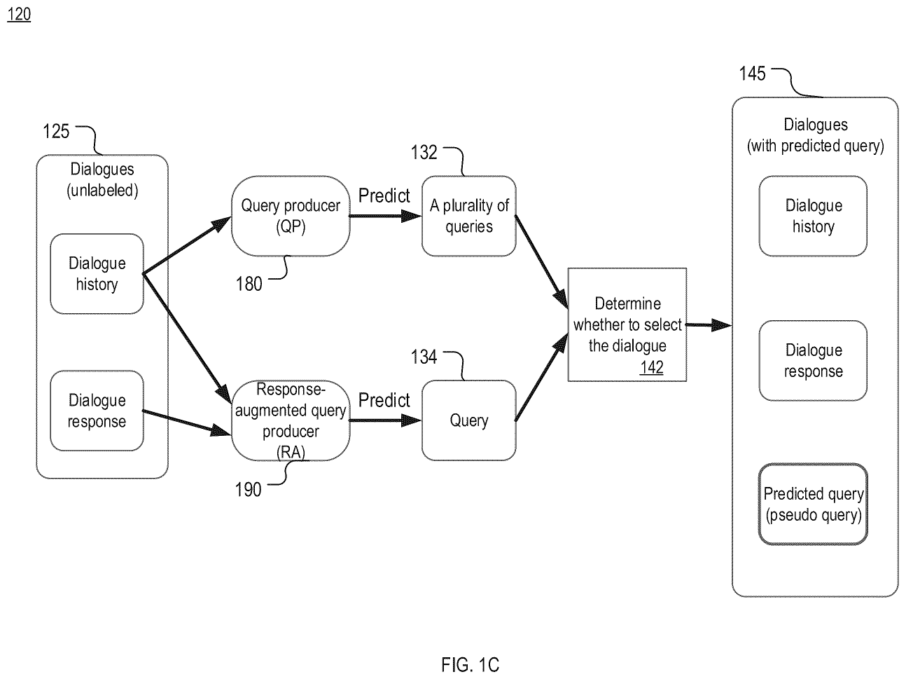

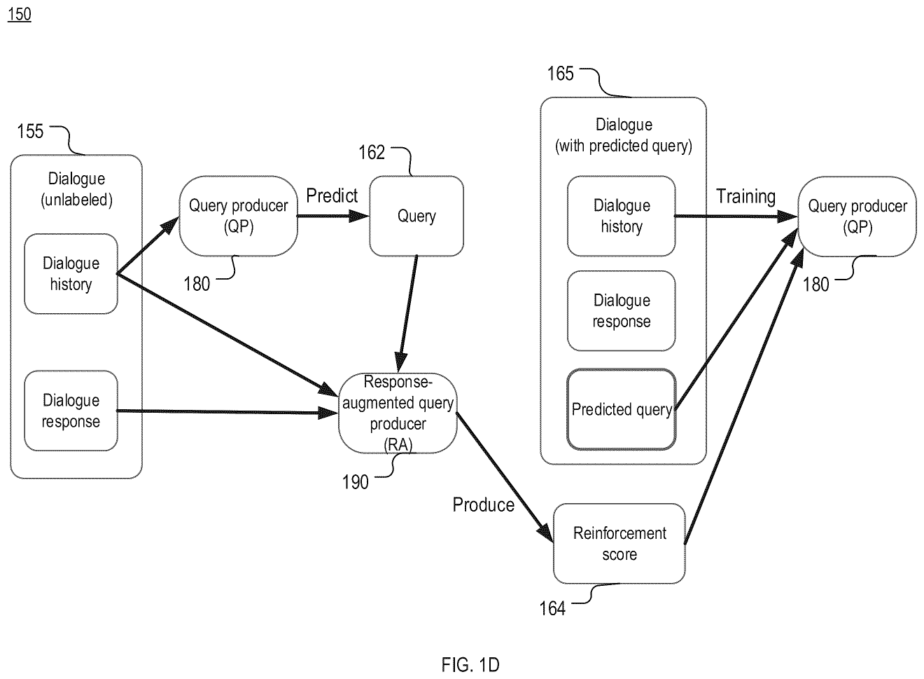

FIG. 1A shows a schematic diagram of one exemplary embodiment 100 for training a query producer in the present disclosure. The training scheme may include a portion or all of the following: a stage 1 training 110, a stage 2 training 120, and/or a stage 3 training 150. The training is performed on a query producer (QP) 180 and/or a response-augmented query producer (RA) 190. The stage 1 training may be referred as supervised learning with a plurality of dialogues with labeled query 115 as training samples. The stage 2 training may be referred as semi-supervised training with a plurality of dialogues that are not labeled and do not have labeled query for obtaining its training samples. The stage 3 training may be referred as reinforcement learning with one or more dialogues that are not labeled and do not have labeled query for obtaining its training sample. The dialogue may include a dialogue history portion and a dialogue response portion. More detailed descriptions and examples are described in other portions of the present disclosure.

In some implementations, referring to FIG. 1B, the stage 1 training may include feeding dialogue history and labeled query as training samples to train QP, and/or feeding dialogue history, dialogue response, and labeled query as training samples to train RA.

In some implementations, a QP and an RA may be trained via supervised learning in this stage. Formally, given the dialogue history u<i=u₁, . . . , u_{i_1}, both QP and RA aim to predict the target query q. The difference between QP and RA lies in that RA takes the dialogue response uᵢ as additional input, which is inaccessible in practical application.

In some implementations, a pre-trained text-to-text transfer transformer (T5) may be selected as a basic model for QP and RA, and further fine-tuned on conversations with annotated queries. For each instance, the cross-entropy loss (CE) may be taken as the training objective with the loss functions for QP and RA, respectively:

$${L}_{qp} = - log p ( q \vert {u}_{< i} ; {θ}_{q p} )$$

$${L}_{r a} = - log p ( q \vert {u}_{\leq i} ; {θ}_{r a} )$$

wherein θ_{qp} and θᵣₐ denote the parameters of QP and RA respectively.

In some implementations, referring to FIG. 1C, the stage 2 training may include constructing a plurality of dialogues with predicted query (or referred as pseudo query) 145 based on the plurality of unlabeled dialogues 125. The constructed dialogues with predicted queries may serve as training sample to train QP and/or RA. The dialogue history in an unlabeled dialogue may be fed into the QP to predict a plurality of queries 132; and the dialogue history and the dialogue response in the same unlabeled dialogue may be fed into the RA to predict a single query 134. In step 142, the similarity between the query 134 and the plurality of queries 132 may be calculated for determining whether the dialogue is selected to be included in the training samples 145. In some implementations, the RA may predict more than one queries 134, and their similarity from the plurality of queries 132 may be calculated, wherein the query that is among the more than one queries 134 and produces the highest similarity is chosen for determining whether the dialogue is selected to be included in the training samples 145.

The dialogue history and the dialogue response in the dialogues with predicted query 145 are same as the dialogue history and the dialogue response in the unlabeled dialogue 125, respectively; and the predicted query in the dialogue with predicted query 145 is same as the predicted query 134.

In some implementations, constructing the plurality of dialogues with predicted queries 145 completes when a certain condition is satisfied. The condition may include one or all of the following: whether a pre-defined target number of dialogues in the dialogues with predicted queries 145 is reached, and/or whether all dialogues in the unlabeled dialogues 125 are processed.

When the dialogues with predicted queries 145 are constructed, the stage 2 training may proceed with feeding dialogue history and predicted query as training samples to train QP, and/or feeding dialogue history, dialogue response, and predicted query as training samples to train RA.

For one non-limiting example, once the stage 1 training is completed, RA is used to generate queries for an unlabeled dialogue corpus and high-quality queries are selected to construct pseudo instances, which are finally used to enhance QP and RA. Unlike the standard self-training in some implementations, various embodiments in the present disclosure may take advantage of RA rather than QP in generating pseudo queries and constructing instances for QP. One important step of the above process is the quality evaluation of RA-generated queries. Intuitively, the most direct approach is to use their predictive probabilities as the evaluation metric. However, modern neural networks may be poorly calibrated and their predictive probabilities may not be reliable. To deal with this issue, various embodiments in the present disclosure may use QP to generate queries for the unlabeled dialogue corpus and then evaluate the quality of RA-generated queries by the prediction similarity between RA and QP.

Formally, given a dialogue history and response in the unlabeled corpus, RA may be used to generate a query q̅ and adopt QP to generate N queries \hat{Q}={\hat{q}₁, . . . , \hat{q}_{N}} with only dialogue history as input. Then the quality of RA-generated query q̅ may be quantified by the following similarity score:

$${s ( \overline{q} ) = max \{ {F}_{s i m} ( \overline{q} , {\hat{q}}_{i} ) \}}_{{\hat{q}}_{i} ∈ \hat{Q}}$$

wherein Fₛᵢₘ denotes a text similarity function that returns the score of a specific quantitative metric (e.g., Unigram F1 and ROUGE) or a semantic similarity model such as Sentence-BERT. Note that if q̅ is overly influenced by the response information, it will contain unrelated concepts from the response and thus will have a low similarity score.

Afterward, high-quality RA-generated queries, whose similarity score exceeds a pre-determined threshold α, are selected to construct pseudo instances with the corresponding dialogue histories. Next, these pseudo instances are used to further train QP using the CE loss again. Particularly, during this process, the training strategies that are adopted may vary slightly in different scenarios. Concretely, in the cross-domain scenario (e.g., from a health care domain to a consumer electronics domain), various embodiments in the present disclosure may directly fine-tune the best checkpoints of QP from Stage 1 on RA-labeled pseudo instances. While in the lower-source scenario, various embodiments in the present disclosure may retrain QP on RA-labeled pseudo instances. In some implementations, various embodiments in the present disclosure may also further train RA in the above manners to facilitate the subsequent training.

In some implementations, referring to FIG. 1D, the stage 3 training may include constructing one or more dialogues with predicted query (or referred as pseudo query) 165 and generating a reinforcement score 164 for training the QP. A dialogue history of a unlabeled dialogue 155 may be fed into QP to predict a query 162. The query 162, along with the dialogue history and the dialogue response of the unlabeled dialogue, may be fed into the RA to produce the reinforcement score 164. The dialogue history and the predicted query in the dialogue with predicted query 165 are used to train the QP based on the reinforcement score.

The dialogue history and the dialogue response in the dialogue with predicted query 165 are same as the dialogue history and the dialogue response in the unlabeled dialogue 155, respectively; and the predicted query in the dialogue with predicted query 165 is same as the predicted query 162.

For one non-limiting example: there are still some low-quality pseudo instances left from stage 2 training, which may have negative effects. More importantly, QP may still fail to fully utilize useful fine-grained training signals from RA by training on pseudo instances only. Thus, in Stage 3, the REINFORCE algorithm may be adopted to tackle these problems. Concretely, for each instance in an unlabeled dialogue corpus, various embodiments in the present disclosure may first sample Ne candidate queries from the predictive distribution of QP. A length-normalized log probability of QP for each candidate query Q may be calculated as below:

$${f}_{qp} ( {\hat{q}}^{c} ) = \frac{{\sum }_{j} log p ( {\hat{q}}^{c} \vert {u}_{< i} , {\hat{q}}_{< j}^{c} ; {θ}_{qp} )}{\vert {\hat{q}}^{c} \vert}$$

wherein \hat{q}ⱼ^{c} denotes the j-th query token. Furthermore, using a softmax normalization, a predictive distribution over all candidate queries may be derived, acting as the stochastic policy to sample \hat{q}^{c}.

In some implementations, A portion or all of the following two kinds of reward r(\hat{q}^{c}) may be used, wherein the reinforcement score may correspond to the reward (e.g., being the same in some implementations). One is prob-based reward, wherein each candidate query \hat{q}^{c} is fed into RA and its length normalized log probability is calculated, denoted as fᵣₐ(\hat{q}^{c}); and this probability may be directly used as the reward: r(\hat{q}^{c})=fᵣₐ(\hat{q}^{c}). Another is rank-based reward, wherein all candidate queries are sorted by fᵣₐ(\hat{q}^{c}) and the following reward is used: r(\hat{q}^{c})=1/1+g(\hat{q}^{c}) where g(*) is a function that returns the descending order of input queries.

Finally, QP can be trained with the guidance of reward:

$${L}_{l r} = - r ( {\hat{q}}^{c} ) log p ( {\hat{q}}^{c} \vert {u}_{< i} ; {θ}_{qp} )$$

In some implementations, intuitively, the reward provided by RA is a fine-grained training signal compared to the pseudo queries in Stage 2.

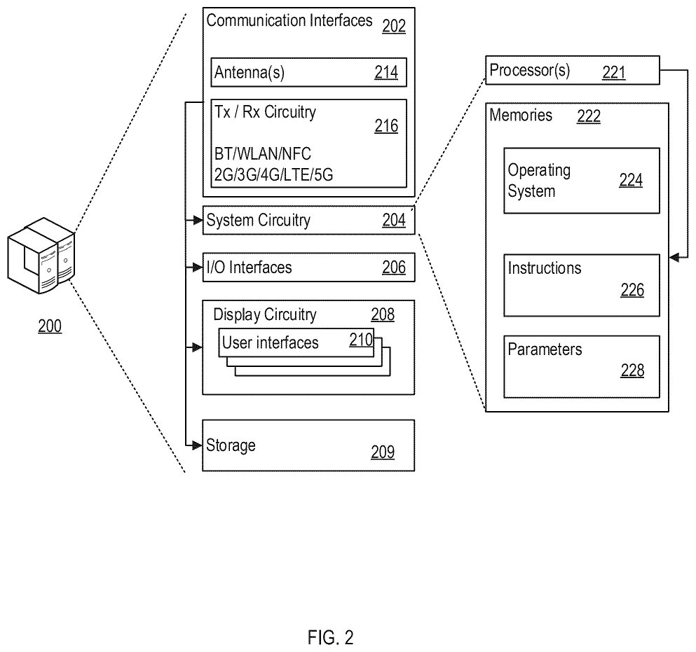

FIG. 2 shows an example of an electronic device 200 to implement one or more method described in the present disclosure. In one implementation, the electronic device 200 may be at least one of a computer, a server, a laptop, or a mobile device. In another implementation, the electronic device 200 may be a set of electronic devices comprising at least one of one or more computing server, one or more data server, one or more network server, one or more terminal, one or more laptop, and/or one or more mobile device.

The electronic device 200 may include communication interfaces 202, a system circuitry 204, an input/output interfaces (I/O) 206, a display circuitry 208, and a storage 209. The display circuitry may include a user interface 210. The system circuitry 204 may include any combination of hardware, software, firmware, or other logic/circuitry. The system circuitry 204 may be implemented, for example, with one or more systems on a chip (SoC), application specific integrated circuits (ASIC), discrete analog and digital circuits, and other circuitry. The system circuitry 204 may be a part of the implementation of any desired functionality in the electronic device 200. In that regard, the system circuitry 204 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 210. The user interface 210 and the inputs/output (I/O) interfaces 206 may include a graphical user interface, touch sensitive display, haptic feedback or other haptic output, voice or facial recognition inputs, buttons, switches, speakers and other user interface elements. Additional examples of the I/O interfaces 206 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 2, the communication interfaces 202 may include wireless transmitters and receivers (“transceivers”) and any antennas used by the transmitting and receiving circuitry of the transceivers. The communication interfaces 202 may also include wireline transceivers, which may provide physical layer interfaces for any of a wide range of communication protocols, such as any type of Ethernet, data over cable service interface specification (DOCSIS), digital subscriber line (DSL), Synchronous Optical Network (SONET), or other protocol. The communication interfaces 202 may include a Radio Frequency (RF) transmit (Tx) and receive (Rx) circuitry 216 which handles transmission and reception of signals through one or more antennas 214. The communication interface 202 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 202 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

The system circuitry 204 may include hardware, software, firmware, or other circuitry in any combination. The system circuitry 204 may be implemented, for example, with one or more systems on a chip (SoC), application specific integrated circuits (ASIC), microprocessors, discrete analog and digital circuits, and other circuitry. For example referring to FIG. 2, the system circuitry 204 may include one or more processors 221 and memories 222. The memory 222 stores, for example, an operating system 224, instructions 226, and parameters 228. The processor 221 is configured to execute the instructions 226 to carry out desired functionality for the electronic device 200. The parameters 228 may provide and specify configuration and operating options for the instructions 226. The memory 222 may also store any BT, WiFi, 3G, 4G, 5G or other data that the electronic device 200 will send, or has received, through the communication interfaces 202. In various implementations, a system power for the electronic device 200 may be supplied by a power storage device, such as a battery or a transformer.

The storage 209 may be used to store various initial, intermediate, or final data. In one implementation, the storage 209 may be integral with a database server. The storage 209 may be centralized or distributed, and may be local or remote to the electronic device 200. For example, the storage 209 may be hosted remotely by a cloud computing service provider.

The present disclosure describes various embodiments, which may be implemented, partly or totally, on the one or more electronic device described in FIG. 2.

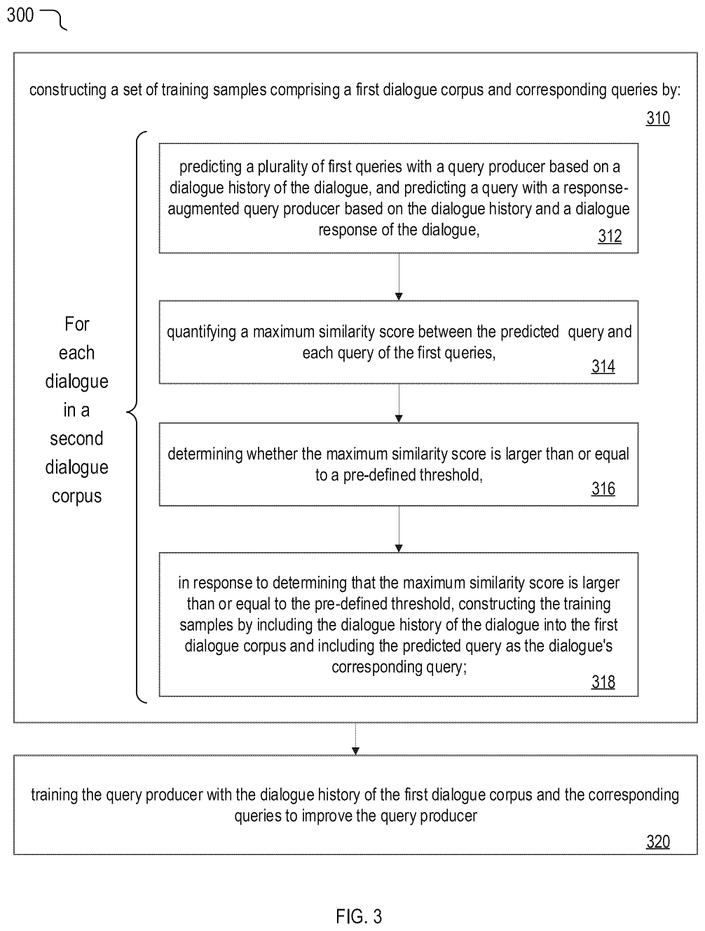

Referring to FIG. 3, the present disclosure describes embodiments of a method 300 for improving/training a query producer. The method is performed by a device including one or more memories and one or more processors in communication with the one or more memories. The method 300 may include a portion or all of the following steps: step 310, constructing a set of training samples comprising a first dialogue corpus and corresponding queries by a portion or all of the following, for each dialogue in a second dialogue corpus: step 312, predicting a plurality of first queries with a query producer based on a dialogue history of the dialogue, and predicting a query with a response-augmented query producer based on the dialogue history and a dialogue response of the dialogue, step 314, quantifying a maximum similarity score between the predicted query and each query of the first queries, step 316, determining whether the maximum similarity score is larger than or equal to a pre-defined threshold, and/or step 318, in response to determining that the maximum similarity score is larger than or equal to the pre-defined threshold, constructing the training samples by including the dialogue history of the dialogue into the first dialogue corpus and including the predicted query as the dialogue's corresponding query; and/or step 320, training the query producer with the dialogue history of the first dialogue corpus and the corresponding queries to improve the query producer. Each of the query producer and the response-augmented query producer comprises a text-to-text transformer.

In some implementations, additional or alternatively to any or any combination of implementations or embodiments described in the present disclosure, the text-to-text transformer comprises a neural network.

In some implementations, additional or alternatively to any or any combination of implementations or embodiments described in the present disclosure, the method further includes pre-training the query producer with a third dialogue corpus and labeled queries; and/or pre-training the response-augmented query producer with the third dialogue corpus and labeled queries.

In some implementations, additional or alternatively to any or any combination of implementations or embodiments described in the present disclosure, each dialogue of the third dialogue corpus comprises a dialogue history and a dialogue response; the pre-training the query producer with the third dialogue corpus and the labeled queries comprises: pre-training the query producer with the dialogue history of the third dialogue corpus and the labeled queries; and/or the pre-training the response-augmented query producer with the third dialogue corpus and the labeled queries comprises: pre-training the response-augmented query producer with the dialogue history and the dialogue response of the third dialogue corpus and the labeled queries.

In some implementations, additional or alternatively to any or any combination of implementations or embodiments described in the present disclosure, the second dialogue corpus comprises a plurality of unlabeled dialogues; and/or each dialogue of the plurality of unlabeled dialogues comprises the dialogue history and the dialogue response.

In some implementations, additional or alternatively to any or any combination of implementations or embodiments described in the present disclosure, the method further includes predicting a query with the trained query producer based on an input dialogue, wherein the predicted query is for predicting a response to the input dialogue.

In some implementations, additional or alternatively to any or any combination of implementations or embodiments described in the present disclosure, the method further includes training the response-augmented query producer with the dialogue history and the dialogue response of the first dialogue corpus and corresponding queries to improve the response-augmented query producer.

In some implementations, additional or alternatively to any or any combination of implementations or embodiments described in the present disclosure, the method further includes further training the query producer with reinforcement learning by: predicting a query with the query producer based on a dialogue history of an input dialogue, producing a reinforcement score with the response-augmented query producer based on the predicted query and the dialogue history and a dialogue response of the input dialogue, and/or training the query producer based on the produced reinforcement score, the dialogue history of the input dialogue, and the predicted query.

In some implementations, additional or alternatively to any or any combination of implementations or embodiments described in the present disclosure, the method further includes, during training the query producer based on the produced reinforcement score, the dialogue history of the input dialogue, and the predicted query, modifying a loss function according to the produced reinforcement score.

The present disclosure describes various embodiments for training a query producer for improving its effectiveness in predicting query based on dialogue history. The methods in various embodiments may be roughly separated into three stages. In Stage 1, the method includes training a standard query producer (QP) and a response-augmented query producer (RA) on a labeled dataset via supervised learning. In Stage 2, both QP and RA generate pseudo queries for an unlabeled dialogue corpus. Then, based on the prediction similarity between RA and QP, the method includes selecting high-quality RA-generated queries to construct pseudo instances for training these two models. Nevertheless, due to the discrepancy between QP and RA, these pseudo instances might not effectively guide QP. Thus, in Stage 3, the method includes employing reinforcement learning to further improve QP with RA providing rewards as fine-grained training signals.

Below, the present disclosure further describes detailed aspects of various embodiments for training a query producer for improving its effectiveness in predicting query based on dialogue history. The present disclosure describes one or more detailed examples, which does not impose any limitation on the applicability or scope of the present disclosure.

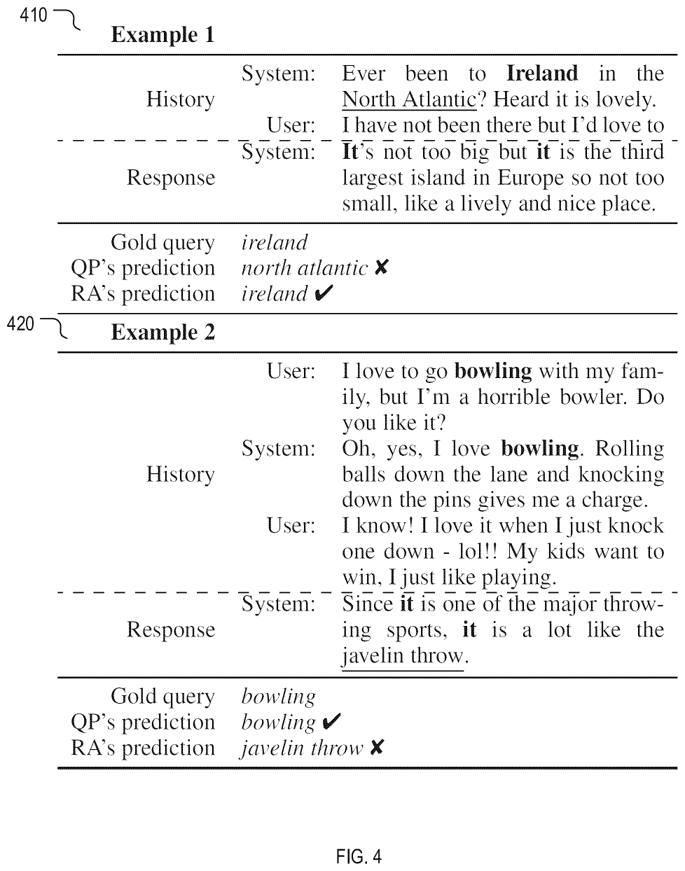

In some implementations, a search query can be highly relevant to the topic of its corresponding dialogue response. When augmenting the input with response information, the model can often generate better search queries. As illustrated in 410 of FIG. 4, the standard query producer (QP) solely incorporates the dialogue history as input and mistakenly recognizes “north atlantic” as the query. In contrast, the response-augmented query producer (RA) accurately predicts the correct query by inferring the mainly discussed topic “ireland” (referred to by “it”) in the response. This demonstrates the potential of RA to generate high-quality pseudo queries which can subsequently be used to construct pseudo instances for training QP¹ However, we notice that RA may also generate some low-quality queries especially when it is overly influenced by the response. In 420 of FIG. 4, RA ignores the principal topic “bowling” in the history, but mistakenly takes “javelin throw”, another topic in the response, as the prediction. Therefore, it is worth exploring ways to select high-quality RA-generated pseudo queries.

Based on the observations above, a novel framework, semi-supervised dialogue query generation (SemiDQG), may be used to effectively improve QP with the guidance of RA. Specifically, a method using such framework includes first training QP and RA on a labeled dataset; subsequently, leveraging the capabilities of RA to generate pseudo queries for an unlabeled dataset and introducing a query selection strategy based on the prediction similarity between QP and RA to select high-quality RA-generated queries (e.g., “ireland” in FIG. 4). In a semi-supervised manner, these selected queries are used to construct pseudo instances, thereby enhancing the performance of both models. Finally, to further enhance QP, the method includes adopting the REINFORCE algorithm with RA-provided rewards, serving as fine-grained training signals, based on QP-generated candidate queries. Both pseudo instance construction and the reinforcement learning approach proposed above can jointly consider the output features from both QP and RA. Thus, it can fully utilize the training signals from RA spanning different levels of granularity and effectively alleviate the negative effect stemming from input discrepancy between the two models.

In some implementations, experiments in cross-domain and low-resource scenarios may be conducted respectively. In the cross-domain scenario, the method may include constructing Wizard-of-Internet (WoI)→Wizard-of-Wikipedia (WoW) in English, and DuSinc→KdConv in Chinese. In the low-resource scenario, the method may focus on WoI as it provides more data for better evaluation. Experiment results show that SemiDQG significantly outperforms ChatGPT and various baselines. Moreover, in-depth analysis validates the effectiveness of the proposed query selection strategy and reinforcement learning method in the framework.

Using a search engine to exploit knowledge from the Internet is gaining popularity for benefiting various knowledge-intensive tasks, such as open-domain QA, and dialogue response generation. Early attempts simply take user questions or keywords as search queries but have been proven to be ineffective when handling distinct domains or complex dialogue contexts. Methods in some implementations train a query producer to extract or generate search queries, with query generation more popular due to the limitation of extraction. With the release of various query generation datasets query producers in supervised learning manners may be created. As query annotations are costly to collect, additional supervision signals to train their query producers may be implemented.

In some implementations, many LLM products use prompting techniques to generate search queries instead of adopting an independent query producer. However, prompting techniques heavily rely on the ability of LLMs to understand the prompt. After a comparison of these two strategies, experimental results in the present disclosure show that even ChatGPT still shows inferior performance than a smaller task-specific model.

As a branch of machine learning, semi-supervised learning exploits the knowledge from unlabeled data when labeled data is limited. In this regard, typical methods mainly include self-training, co-training, tri-training, and so on. Among them, self-training is one of the earliest approaches and continues to gain popularity in recent years. For a specific task, it improves a model by iteratively enriching the training data with selected pseudo instances. In NLP fields, self-training on text generation tasks may be used, such as neural machine translation, text summarization, and question generation. Nevertheless, it is challenging to collect appropriate pseudo instances, potentially hindering the progress in building more powerful models. Various embodiments in the present disclosure may leverage semi-supervised learning to further enhance the query producer.

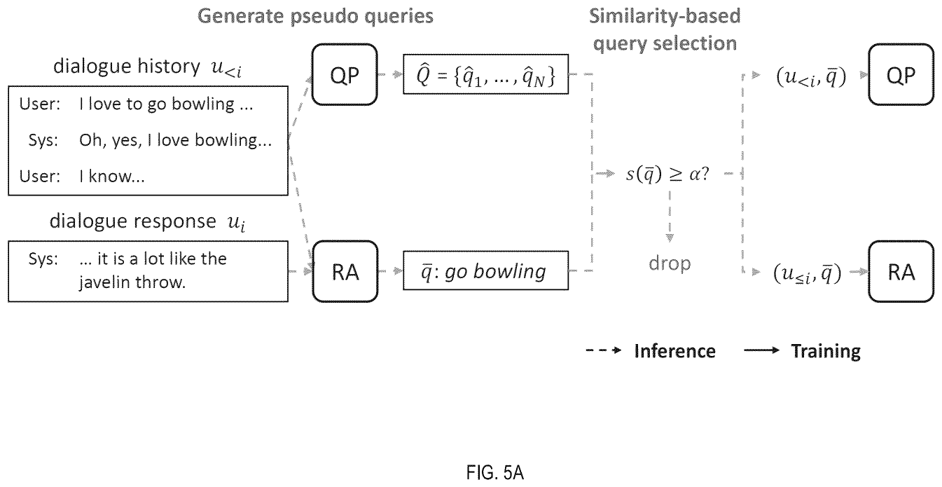

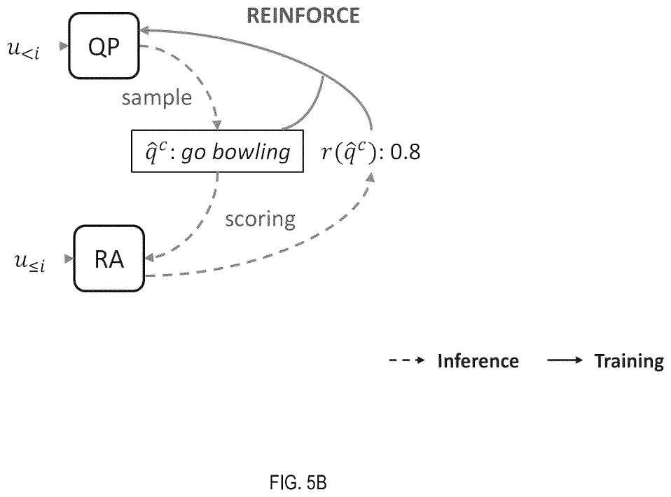

FIGS. 5A and 5B illustrates the procedure of an exemplary embodiment of SemiDQG, which can be roughly separated into three stages. In Stage 1, a standard query producer (QP) and a response-augmented query producer (RA) are trained on a labeled dataset via supervised learning. In Stage 2 in FIG. 5A, both QP and RA generate pseudo queries for an unlabeled dialogue corpus. Then, based on the prediction similarity between RA and QP, high-quality RA-generated queries are selected to construct pseudo instances for training these two models, wherein the query whose similarity score s(q⁻) exceeds a given threshold α is kept to construct a pseudo instance. Nevertheless, due to the discrepancy between QP and RA, these pseudo instances might not effectively guide QP. Thus, in Stage 3 in FIG. 5B, reinforcement learning is used to further improve QP with RA providing rewards as fine-grained training signals.

In various embodiments, experiments may be conducted in both cross-domain and low-resource scenarios across three benchmarks: in the cross-domain scenario, Wizard-of-Internet (WoI)→Wizard-of-Wikipedia (WoW) in English, and DuSinc→KdConv in Chinese; and in the low-resource scenario, WoI is focused on, which provides more high-quality query annotation data for better evaluation.

Wizard-of-Internet (WoI) A comprehensive dataset providing conversations with search query annotations and websites retrieved from the Bing Search API.

Wizard-of-Wikipedia (WoW) A popular dialogue dataset, with each utterance grounded on a Wikipedia page. Wikipedia Search is used as the search engine and the quality of search queries is evaluated by comparing retrieved Wikipedia page titles with the gold one.

DuSinc A Chinese open-domain dialogue dataset with annotated search queries, and its publicly available part is used for experiments.

KdConv A Chinese multi-domain knowledge-driven conversation dataset containing knowledge graph (KG) triplets where dialogue responses may need knowledge from a KG. For each triplet, the concatenation of the subject and the predicate as the gold query is used.

In various embodiments, the metrics that are use to evaluate the model performance are listed below:

Recall-k (R@k) this metric is used only on WoW. It is decided by the recall of the target Wikipedia page title when feeding the top-k (k∈{1, 3}) predicted queries to Wikipedia search.

Unigram F1 (Uni. F1) This metric is used on all the datasets. It measures the unigram overlap between the prediction and gold reference.

BLEU It is a typical metric for text generation tasks that mainly focus on the precision of n-gram for the prediction against the gold reference. sacrebleu is used for BLEU-1/2 calculation.

ROUGE As another commonly used evaluation metric for text generation, it accounts for both precision and recall, thus providing more comprehensive scores. ROUGE-1/2/L is reported using Google's implementation.

In various embodiments, the performance of SemiDQG is compared with the following baselines.

T5-base A fine-tuned T5-base model on a labeled dataset, same as QP in Stage 1 as mentioned above.

Self-training (scratch) A model initialized from the original T5-base parameters and trained on the QP-labeled pseudo instances.

Self-training (QP) A model initialized from trained QP in Stage 1 and then tuned on self-labeled pseudo instances.

Self-training (joint) The original T5-base model fine-tuned on the combination of synthetic data and authentic data.

QP-ext/QP-gen Different types of QPs, based on extraction and generation respectively. Both are trained with cheap noisy supervision, taking feedback from the Wikipedia search as training signals, and significantly surpass unsupervised keyword extraction methods.

KD (RA→QP) A model that adopts vanilla knowledge distillation, where the student model (QP) is trained to fit predictions of the teacher model (RA).

ChatGPT The official gpt-3.5-turbo API is used to perform inference by in-context learning with 3 or 8 demonstrations.

In various embodiments, for all pre-trained models used in this work, the checkpoints from Huggingface are used, with different T5-base variants according to languages. For English datasets, the t5-base is used. While for Chinese datasets, the Langboat/mengzi-t5-base is used. During training, an Adam optimizer is applied, with a linear scheduler and an initial learning rate of 3e-5. A batch size of 64 is used for cross-domain experiments and 16 for low-resource counterparts. For the main experiments, N=1 for query selection, and Unigram F1 as the default Fₛᵢₘ. The selection of hyperparameter a for WoW/WoI/KdConv is 1.0/1.0/0.5, respectively. N_{c}=10 for rank-based reward in the cross-domain scenario and N_{c}=3 for other settings.

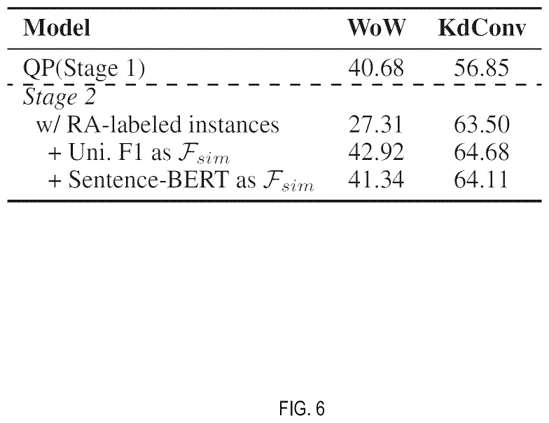

Selection of Fₛᵢₘ In Stage 2, two types of Fₛᵢₘ, are investigated: Unigram F1 as the quantitative metric and Sentence-BERT as the semantic similarity model. As shown in FIG. 6, both Fₛᵢₘ can effectively enhance QP, and the semantic similarity model does not necessarily yield better results than conventional quantitative metrics. Thus, in some implementations, Uni. F1 is taken as the Fₛᵢₘ for some later experiments. FIG. 6 shows results on development sets of WoW and KdConv with different Fₛᵢₘ in Stage 2.

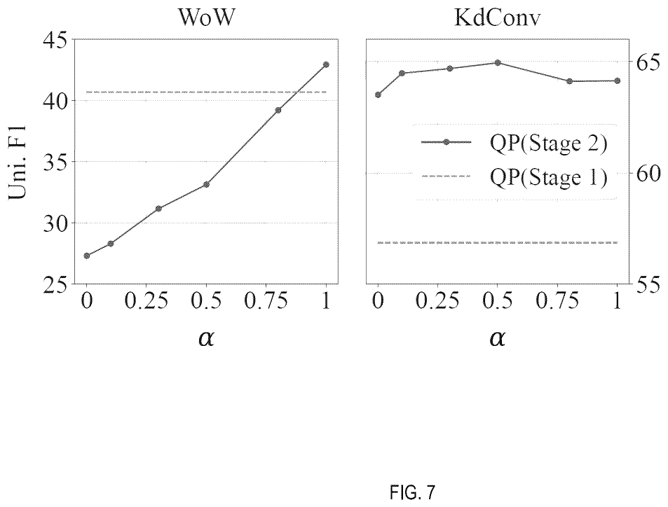

Selection of α α=0, 0.1, 0.3, 0.5, 0.8, 1.0 are explored on WoW and KdConv. As shown in FIG. 7, the selection of the threshold α significantly affects the model performance. The model reaches the best performance when α=1.0/0.5, demonstrating the effectiveness of the similarity-based query selection. Especially, the model performs even worse than QP (Stage 1) when taking a small α on WoW. This may be attributed to the larger domain gap existing between WoI and WoW. Nevertheless, this still emphasizes the necessity of adopting the query selection strategy. For DuSinc→KdConv, the gap may be closer, thus setting a relatively lower a can provide a more diverse set of high-quality pseudo instances to boost the model performance. FIG. 7 shows effect of α on Unigram F1 for development sets of WoW and KdConv in Stage 2.

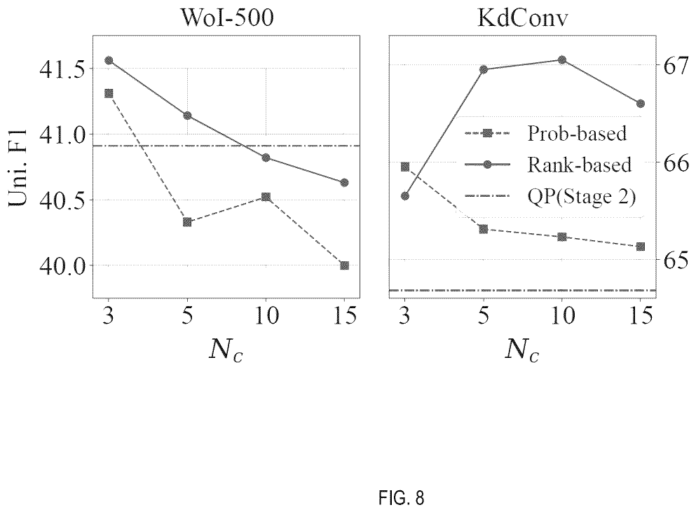

Selection of N_{c} and Reward Types The selection of reward types (prob-based and rank-based) with N_{c}=3, 5, 10, 15 are explored for two scenarios separately, as shown in FIG. 8. Generally, prob-based reward only works better when N_{c} is small, and is inferior to rank-based reward, especially in the cross-domain scenario. This is because poorly calibrated RA cannot provide reasonable confidence scores due to domain discrepancy. Furthermore, larger N_{c} leads to performance degradation in both scenarios since a large N_{c} will introduce more diverse but low-quality candidates. FIG. 8 shows results on development sets of WoI and KdConv, with different N_{c} for probability-based and rank-based rewards.

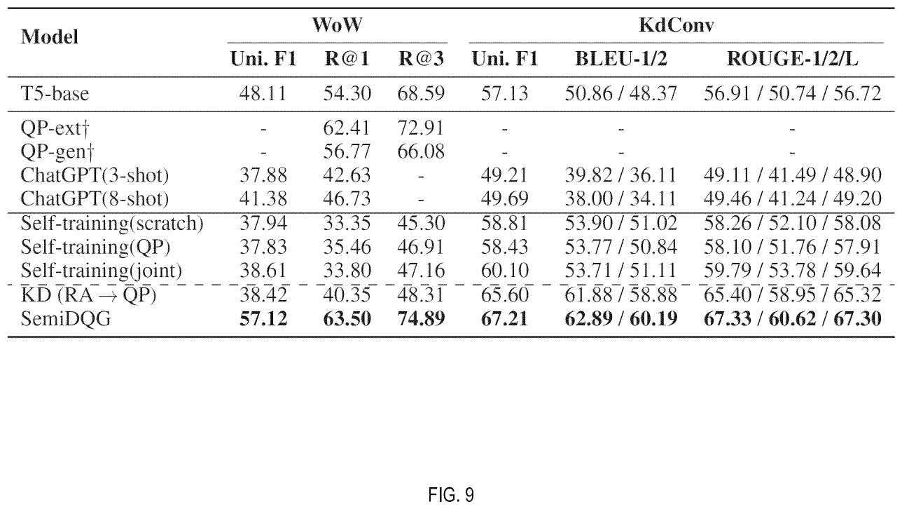

Cross-domain Scenario FIG. 9 shows the main results in the cross-domain scenario. Overall, SemiDQG achieved the best result, exhibiting remarkable superiority over all baselines across all metrics. While exceeding the typical selftraining, it also surpasses other competitive baselines, even the famous LLM product ChatGPT. An in-depth analysis may yield the following findings.

Currently accepted LLMs still fail to handle the dialogue query generation task well, despite the application of in-context learning. As the number of demonstrations increases from 3 to 8, ChatGPT exhibits some performance improvement on WoW, yet it still falls short of expectations compared to a task-specific model. It is believed that the capabilities of LLMs should be further explored, as the performance of in-context learning may be constrained.

The two competitive baselines, QP-ext and QP-gen, exhibit performance closest to SemiDQG on WoW. However, their training costs are higher due to the use of search engines as feedback. Besides, both QP-ext and QP-gen are trained to predict continuous entity spans from inputs. This also makes their approaches impractical on distinct datasets.

Traditional self-training may hurt model performance. As shown in FIG. 9, none of the three self-training variants improve the performance of QP on WoW, and even lead to a decline. Meanwhile, the performance improvement on KdConv is also limited. These results reflect the negative impact of low-quality pseudo instances. It is also observed that Self-training (scratch) slightly outperforms Selftraining (QP) due to different model initializations.

With the guidance of RA, KD (RA→QP) beats all self-training approaches on KdConv, demonstrating the necessity of leveraging response information. However, it also performs worse on WoW compared with T5-base similar to self-training baselines. The SemiDQG successfully improves results on both datasets and significantly outperforms KD (RA→QP), validating its effectiveness.

FIG. 9 shows test results on WoW and KdConv in the cross-domain scenario. † denotes the results reported in other publication. Note that ChatGPT is only requested to generate the most relevant query for each instance, so its R@3 is not applicable.

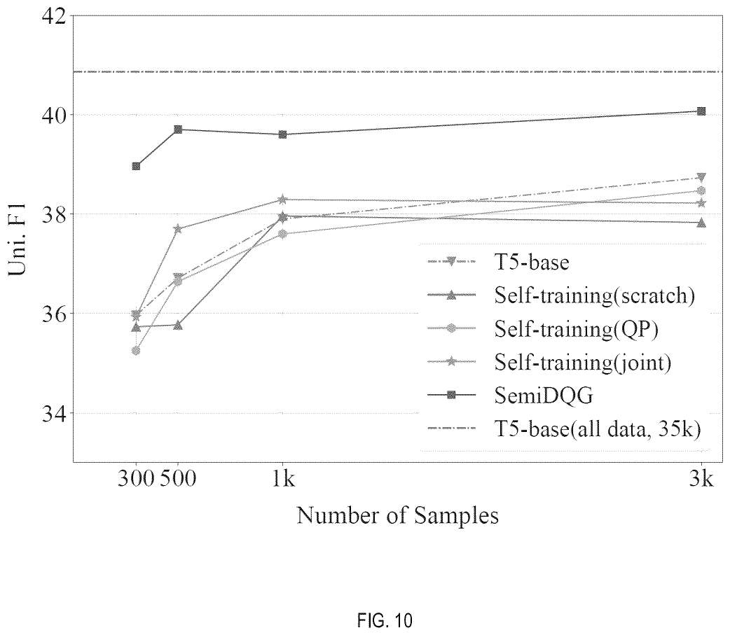

Low-resource Scenario FIG. 10 depicts that SemiDQG also demonstrates its effectiveness in the low-resource scenario on WoI, which achieves greater performance improvement under extremely low-resource settings (300/500-shot). Besides, when using 300 labeled instances, SemiDQG out-performs a T5-base trained with 3 k instances, which is 10 times data efficiency. In addition, similar to the cross-domain results, the performance of the three traditional self-training variants is suboptimal in the low-resource scenario on WoI. This also highlights the limitations of traditional methods and the effectiveness of SemiDQG. FIG. 10 shows Unigram F1 test results on WoI in the low-resource scenario.

In the present disclosure, DuSinc→KdConv may be taken as an example to conduct a detailed analysis of the framework.

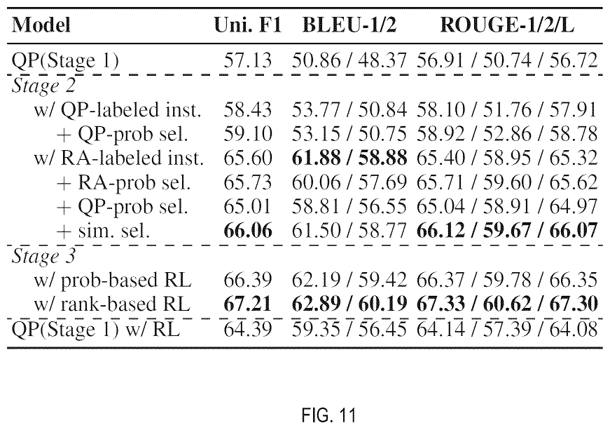

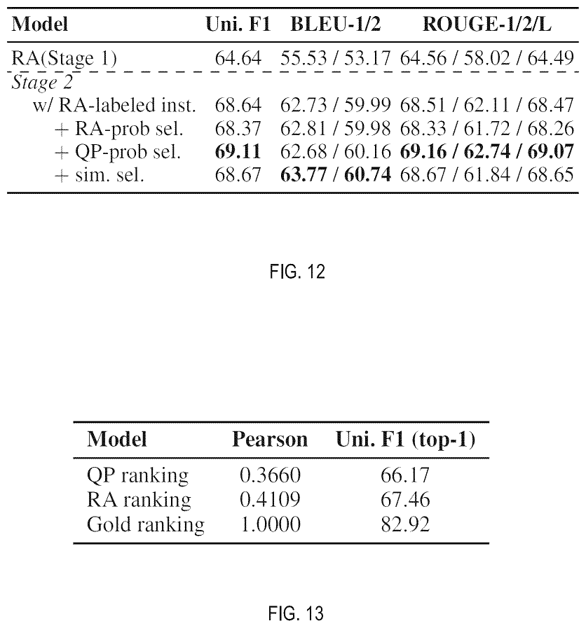

Similarity-based Query Selection (Stage 2) Ablation studies are conducted as shown in FIGS. 11 and 12, comparing methods with query selection based on predictive probabilities of either QP or RA. The main findings are as follows. FIG. 11 shows ablation studies of QP on the KdConv test set. Here “instances”, “similarity” and “selection” are abbreviated as “inst.”, “sim.” and “sel.”, respectively. FIG. 12 shows test results of RA variants on KdConv.

RA-labeled instances benefit QP more. The utilization of QP-labeled pseudo instances can only slightly enhance QP on KdConv, and the improvement of adopting query selection based on its predictive probability is also limited.

The quality of RA-labeled pseudo instances significantly affects the performance of QP. Similarity-based query selection works the best among these selection strategies on KdConv, despite a slight decrease in BLEU-1/2 compared to the vanilla knowledge distillation setting. Besides, both QP and RA have difficulty recognizing better pseudo queries, making probability-based query selection less effective than that of the similarity-based counterpart.

RA can also benefit from QP. As depicted in FIG. 12, it is challenging for RA to identify instances that can result in significant self-improvement, highlighting its limitation in self-calibration. Nevertheless, with the guidance of QP, in terms of either predictive probability or prediction similarity, RA can be further enhanced.

RA as the Reward Model (Stage 3) FIG. 11 indicates that RA can effectively guide QP to improve model performance, regardless of whether it is adopted directly after Stage 1 or adopted after Stage 2. As the reward model, RA can provide fine-grained training signals during QP's reinforcement learning process, further tapping into the potential of RA. This validates the necessity and effectiveness of Stage 3.

In various embodiments, further analysis demonstrates that RA can provide more reasonable rewards for QP training, which intuitively decides the performance of QP after Stage 3. As RA is asked to assess each query \hat{q}^{c} from the N_{c} candidates at this stage, whether RA can provide a better ranking to these candidate queries according to their quality is checked.

In detail, the following rankings are compared, as shown in FIG. 13: (1) QP ranking, as previously mentioned, QP is used to sample the N_{c} candidate queries via beam search, which naturally results in a descending ranking based on its predictive probability. (2) RA ranking, the ranking is obtained by sorting the length-normalized log probability of RA fᵣₐ(\hat{q}^{c}) in descending order for each candidate query \hat{q}^{c}. (3) Gold ranking, the Unigram F1 scores between each \hat{q}^{c} and the gold query q, obtaining an oracle ranking by sorting the scores.

To evaluate the quality of each ranking, Pearson correlation coefficients are calculated between the QP/RA ranking and the gold ranking and Uni. F1 (top-1), which gives the Unigram F1 score between the candidate query ranked highest and the gold reference q.

As shown in FIG. 13, the RA ranking has a stronger correlation with the gold ranking and gives higher Uni. F1 (top-1) score. This demonstrates the effectiveness of the RA ranking, as it succeeds in allowing high-quality candidate queries to be ranked higher, thus providing more reasonable rewards when applying reinforcement learning. However, it is also noticed that there is still a significant performance gap between the RA ranking and the gold ranking. It is believed that the potential of RA can be further explored. FIG. 13 shows effect of different ranking methods for Pearson correlation coefficient and top-1 candidate query performance on the KdConv training set in Stage 3.

The present disclosure describes various embodiments including a semi-supervised learning framework, SemiDQG, to enhance the query producer (QP) with the guidance of the response-augmented query producer (RA). Taking the dialogue response as an additional feature, RA can provide better training signals for QP training. However, it is noticed that the input discrepancy between QP and RA will stop a model from further improving. To alleviate the negative impact of this discrepancy, the output features from both QP and RA are joined considered as training signals for QP training. Specifically, similarity-based query selection is applied to select high-quality RA-generated pseudo queries for training these models and then RA-guided reinforcement learning is adopted to exploit fine-grained knowledge from RA to further improve QP. Experimental results and in-depth analysis in cross-domain and low-resource scenarios demonstrate the effectiveness of the embodiments including SemiDQG.

In the present disclosure, the term “processor” means one processor that performs the defined functions, steps, or operations or a plurality of processors that collectively perform defined functions, steps, or operations, such that the execution of the individual defined functions may be divided amongst such plurality of processors.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be embodied as a signal and/or data stream and/or may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may particularly include a storage medium and instructions stored in or on the medium, and the instructions when executed by the circuitry in a device may cause the device to implement any of the processing described above or illustrated in the drawings.

The implementations may be distributed as circuitry, e.g., hardware, and/or a combination of hardware and software among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

While the particular disclosure has been described with reference to illustrative embodiments, this description is not meant to be limiting. Various modifications of the illustrative embodiments and additional embodiments of the disclosure will be apparent to one of ordinary skill in the art from this description. Those skilled in the art will readily recognize that these and various other modifications can be made to the exemplary embodiments, illustrated and described herein, without departing from the spirit and scope of the present disclosure. It is therefore contemplated that the appended claims will cover any such modifications and alternate embodiments. Certain proportions within the illustrations may be exaggerated, while other proportions may be minimized. Accordingly, the disclosure and the figures are to be regarded as illustrative rather than restrictive.

What is claimed is:

1. A method for improving a query producer, the method comprising:
constructing a set of training samples comprising a first dialogue corpus and corresponding queries by, for each dialogue in a second dialogue corpus:
predicting a plurality of first queries with a query producer based on a dialogue history of the dialogue, and predicting a query with a response-augmented query producer based on the dialogue history and a dialogue response of the dialogue,
quantifying a maximum similarity score between the predicted query and each query of the first queries,
determining whether the maximum similarity score is larger than or equal to a pre-defined threshold, and
in response to determining that the maximum similarity score is larger than or equal to the pre-defined threshold, constructing the training samples by including the dialogue history of the dialogue into the first dialogue corpus and including the predicted query as the dialogue's corresponding query; and
training the query producer with the dialogue history of the first dialogue corpus and the corresponding queries to improve the query producer,
wherein each of the query producer and the response-augmented query producer comprises a text-to-text transformer.

2. The method of claim 1, wherein:
the text-to-text transformer comprises a neural network.

3. The method of claim 1, further comprising:
pre-training the query producer with a third dialogue corpus and labeled queries; and
pre-training the response-augmented query producer with the third dialogue corpus and labeled queries.

4. The method of claim 3, wherein:
each dialogue of the third dialogue corpus comprises a dialogue history and a dialogue response;
the pre-training the query producer with the third dialogue corpus and the labeled queries comprises:
pre-training the query producer with the dialogue history of the third dialogue corpus and the labeled queries; and
the pre-training the response-augmented query producer with the third dialogue corpus and the labeled queries comprises:
pre-training the response-augmented query producer with the dialogue history and the dialogue response of the third dialogue corpus and the labeled queries.

5. The method of claim 1, wherein:
the second dialogue corpus comprises a plurality of unlabeled dialogues; and
each dialogue of the plurality of unlabeled dialogues comprises the dialogue history and the dialogue response.

6. The method of claim 1, further comprising:
predicting a query with the trained query producer based on an input dialogue, wherein the predicted query is for predicting a response to the input dialogue.

7. The method of claim 1, further comprising:
training the response-augmented query producer with the dialogue history and the dialogue response of the first dialogue corpus and corresponding queries to improve the response-augmented query producer.

8. The method of claim 7, further comprising:
further training the query producer with reinforcement learning by:
predicting a query with the query producer based on a dialogue history of an input dialogue,
producing a reinforcement score with the response-augmented query producer based on the predicted query and the dialogue history and a dialogue response of the input dialogue, and
training the query producer based on the produced reinforcement score, the dialogue history of the input dialogue, and the predicted query.

9. The method of claim 8, further comprising:
during training the query producer based on the produced reinforcement score, the dialogue history of the input dialogue, and the predicted query, modifying a loss function according to the produced reinforcement score.

10. An apparatus for improving a query producer, the apparatus comprising:
a memory storing instructions; and
a processor in communication with the memory, wherein, when the processor executes the instructions, the processor is configured to cause the apparatus to perform:
constructing a set of training samples comprising a first dialogue corpus and corresponding queries by, for each dialogue in a second dialogue corpus:
predicting a plurality of first queries with a query producer based on a dialogue history of the dialogue, and predicting a query with a response-augmented query producer based on the dialogue history and a dialogue response of the dialogue,
quantifying a maximum similarity score between the predicted query and each query of the first queries,
determining whether the maximum similarity score is larger than or equal to a pre-defined threshold, and
in response to determining that the maximum similarity score is larger than or equal to the pre-defined threshold, constructing the training samples by including the dialogue history of the dialogue into the first dialogue corpus and including the predicted query as the dialogue's corresponding query; and
training the query producer with the dialogue history of the first dialogue corpus and the corresponding queries to improve the query producer,
wherein each of the query producer and the response-augmented query producer comprises a text-to-text transformer.

11. The apparatus according to claim 10, wherein:
the text-to-text transformer comprises a neural network.

12. The apparatus according to claim 10, wherein, when the processor executes the instructions, the processor is configured to further cause the apparatus to perform:
pre-training the query producer with a third dialogue corpus and labeled queries; and
pre-training the response-augmented query producer with the third dialogue corpus and labeled queries.

13. The apparatus according to claim 12, wherein:
each dialogue of the third dialogue corpus comprises a dialogue history and a dialogue response;
the pre-training the query producer with the third dialogue corpus and the labeled queries comprises:
pre-training the query producer with the dialogue history of the third dialogue corpus and the labeled queries; and
the pre-training the response-augmented query producer with the third dialogue corpus and the labeled queries comprises:
pre-training the response-augmented query producer with the dialogue history and the dialogue response of the third dialogue corpus and the labeled queries.

14. The apparatus according to claim 10, wherein:
the second dialogue corpus comprises a plurality of unlabeled dialogues; and
each dialogue of the plurality of unlabeled dialogues comprises the dialogue history and the dialogue response.

15. The apparatus according to claim 10, wherein, when the processor executes the instructions, the processor is configured to further cause the apparatus to perform:
predicting a query with the trained query producer based on an input dialogue, wherein the predicted query is for predicting a response to the input dialogue.

16. The apparatus according to claim 10, wherein, when the processor executes the instructions, the processor is configured to further cause the apparatus to perform:
training the response-augmented query producer with the dialogue history and the dialogue response of the first dialogue corpus and corresponding queries to improve the response-augmented query producer.

17. The apparatus according to claim 16, wherein, when the processor executes the instructions, the processor is configured to further cause the apparatus to perform:
further training the query producer with reinforcement learning by:
predicting a query with the query producer based on a dialogue history of an input dialogue,
producing a reinforcement score with the response-augmented query producer based on the predicted query and the dialogue history and a dialogue response of the input dialogue, and
training the query producer based on the produced reinforcement score, the dialogue history of the input dialogue, and the predicted query.

18. A non-transitory computer readable storage medium storing instructions, wherein, when the instructions are executed by a processor, the instructions are configured to cause the processor to perform:
constructing a set of training samples comprising a first dialogue corpus and corresponding queries by, for each dialogue in a second dialogue corpus:
predicting a plurality of first queries with a query producer based on a dialogue history of the dialogue, and predicting a query with a response-augmented query producer based on the dialogue history and a dialogue response of the dialogue,
quantifying a maximum similarity score between the predicted query and each query of the first queries,
determining whether the maximum similarity score is larger than or equal to a pre-defined threshold, and
in response to determining that the maximum similarity score is larger than or equal to the pre-defined threshold, constructing the training samples by including the dialogue history of the dialogue into the first dialogue corpus and including the predicted query as the dialogue's corresponding query; and
training the query producer with the dialogue history of the first dialogue corpus and the corresponding queries to improve the query producer,
wherein each of the query producer and the response-augmented query producer comprises a text-to-text transformer.

19. The non-transitory computer readable storage medium according to claim 18, wherein, when the instructions are executes by the processor, the instructions are configured to further cause the processor to perform:
training the response-augmented query producer with the dialogue history and the dialogue response of the first dialogue corpus and corresponding queries to improve the response-augmented query producer.

20. The non-transitory computer readable storage medium according to claim 19, wherein, when the instructions are executes by the processor, the instructions are configured to further cause the processor to perform:
further training the query producer with reinforcement learning by:
predicting a query with the query producer based on a dialogue history of an input dialogue,
producing a reinforcement score with the response-augmented query producer based on the predicted query and the dialogue history and a dialogue response of the input dialogue, and
training the query producer based on the produced reinforcement score, the dialogue history of the input dialogue, and the predicted query.
